(19) United States
(12) Patent Application Publication
(10) Pub. No.: US 2022/0199096 A1
(43) Pub. Date: Jun. 23, 2022

(54) INFORMATION PROCESSING APPARATUS AND INFORMATION PROCESSING METHOD

(71) Applicant: SONY GROUP CORPORATION, TOKYO (JP)

(72) Inventors: HIRO IWASE, TOKYO (JP); YUHEI TAKI, TOKYO (JP); KUNIHITO SAWAI, TOKYO (JP); MARI SAITO, TOKYO (JP); SHINICHI KAWANO, TOKYO (JP)

(21) Appl. No.: 17/429,010

(22) PCT Filed: Nov. 29, 2019
(86) PCT No.: PCT/JP2019/046783

§ 371 Date: Aug. 6, 2021

(30) Foreign Application Priority Data
Feb. 15, 2019 (JP) 2019-025766

(51) Int. Cl. G10L 17/24; G10L 17/06; G06F 21/32

(52) U.S. Cl. CPC G10L 17/24; G06F 2221/2103; G06F 21/32; G10L 17/06

(57) ABSTRACT

Provided is an information processing apparatus that includes an authentication dialogue control unit that controls a dialogue with a user and performs a voice authentication process based on a speech that is made by the user in the dialogue. The authentication dialogue control unit generates a challenge speech string including a hash seed word, outputs the challenge speech string as a challenge speech, and performs the voice authentication process on the basis of determination on whether a response speech string that is recognized based on a response speech that is given from the user in response to the output challenge speech includes a hash value word. The hash value word has a predetermined relationship with the hash seed word, where the predetermined relationship is defined by a word relation rule.

### FIELD

The present disclosure relates to an information processing apparatus and an information processing method.

### BACKGROUND

In general, user authentication is usually performed by using a method of inputting identification information and a password. However, in recent years, as an alternative of the method as described above, a technology for performing voice authentication based on voice of a user has been developed. For example, Patent Literature 1 discloses a technology for performing a voice authentication process on the basis of acoustic information on voice spoken by a user and a feature amount of a spoken phrase that is registered in advance by the user.

### CITATION LIST

### Patent Literature

Patent Literature 1: JP 2014-182270 A

### SUMMARY

### Technical Problem

Meanwhile, in voice authentication based on whether a user has spoken a predetermined phrase, if a different person is present near the user at the time of the voice authentication, the different person may hear a speech related to the voice authentication.

However, in contrast, if a speech volume of an apparatus is reduced or a part of information related to the voice authentication is not read in consideration of security, the user may fail to hear or view the information related to the voice authentication. However, in Patent Literature 1, a change of accessibility based on a change of security strength as described above is not taken into account.

### Solution to Problem

According to the present disclosure, an information processing apparatus is provided that includes: an authentication dialogue control unit that controls a dialogue with a user and performs a voice authentication process based on a speech that is made by the user in the dialogue, wherein the authentication dialogue control unit generates a challenge speech string including a hash seed word, outputs the challenge speech string as a challenge speech, and performs the voice authentication process on the basis of determination on whether a response speech string that is recognized based on a response speech that is given from the user in response to the output challenge speech includes a hash value word, and the hash value word has a predetermined relationship with the hash seed word, the predetermined relationship being defined by a word relation rule.

Moreover, according to the present disclosure, an information processing apparatus is provided that includes: an authentication dialogue control unit that controls a dialogue with a user and performs a voice authentication process on the basis of a speech that is made by the user in the dialogue, wherein the authentication dialogue control unit determines security strength of the voice authentication process to be performed, on the basis of a surrounding situation of the recognized user.

Moreover, according to the present disclosure, an information processing method is provided that includes: controlling a dialogue with a user; performing a voice authentication process on the basis of a speech that is made by the user in the dialogue; generating a challenge speech string including a hash seed word; outputting the challenge speech string as a challenge speech; and performing the voice authentication process on the basis of determination on whether a response speech string that is recognized based on a response speech that is given from the user in response to the output challenge speech includes a hash value word, wherein the hash value word has a predetermined relationship with the hash seed word, the predetermined relationship being defined by a word relation rule.

Moreover, according to the present disclosure, an information processing method is provided that includes: controlling a dialogue with a user; performing a voice authentication process on the basis of a speech that is made by the user in the dialogue; and determining security strength of the voice authentication process to be performed, on the basis of a surrounding situation of the recognized user.

### BRIEF DESCRIPTION OF DRAWINGS

FIG. 1 is a diagram for explaining a system configuration example according to the present embodiment.

FIG. 2 is a diagram for explaining an example of a functional configuration of an information processing terminal 10 according to the present embodiment.

FIG. 3 is a diagram for explaining an example of a voice authentication process performed by an authentication dialogue control unit 106 according to the present embodiment.

FIG. 4 is a diagram for explaining an example of a voice authentication process based on the number of different persons recognized by the authentication dialogue control unit 106 according to the present embodiment.

FIG. 5 is a diagram for explaining an example of voice authentication dialogue control including a fake speech FCS by the authentication dialogue control unit 106 according to the present embodiment.

FIG. 6 is a diagram for explaining an example of voice authentication dialogue control including a certain number of fake speeches FCS, where the certain number is determined based on the number of different persons by the authentication dialogue control unit 106 according to the present embodiment.

FIG. 7 is a diagram for explaining an example of a voice authentication process at the time of retry by the authentication dialogue control unit 106 according to the present embodiment.

FIG. 8 is a diagram for explaining an example of the voice authentication process at the time of retry by the authentication dialogue control unit 106 according to the present embodiment.

FIG. 9 is a diagram for explaining an example of a voice authentication process when a different person is not recognized by the authentication dialogue control unit 106 according to the present embodiment.

FIG. 10 is a diagram for explaining an example of a voice authentication process using user personal data by the authentication dialogue control unit 106 according to the present embodiment.

FIG. 11 is a diagram for explaining an example of positive determination and negative determination on a fake response speech string FRSS with respect to the fake speech FCS by the authentication dialogue control unit 106 according to the present embodiment.

FIG. 12 is a diagram for explaining an example of the flow of a process related to voice authentication based on output of a challenge speech CS and a response speech RS by the authentication dialogue control unit 106 according to the present embodiment.

FIG. 13 is a diagram for explaining an example of the flow of a process of generating a challenge speech string CSS by the authentication dialogue control unit 106 according to the present embodiment.

FIG. 14 is a diagram for explaining an example of the flow of a process of determining a hash seed word by the authentication dialogue control unit 106 according to the present embodiment.

FIG. 15A is a diagram for explaining the operational flow of a process related to voice authentication that includes the fake speech FCS and that is performed by the authentication dialogue control unit 106 according to the present embodiment.

FIG. 15B is a diagram for explaining an example of the operational flow of a process related to voice authentication that includes the fake speech FCS and that is performed by the authentication dialogue control unit 106 according to the present embodiment.

FIG. 16 is a block diagram illustrating a hardware configuration example of an information processing terminal 10 and an information processing server 20 according to one embodiment of the present disclosure.

### DESCRIPTION OF EMBODIMENTS

Preferred embodiments of the present disclosure will be described in detail below with reference to the accompanying drawings. In this specification and the drawings, structural elements that have substantially the same functions and configurations will be denoted by the same reference symbols, and repeated explanation of the structural elements will be omitted.

In addition, hereinafter, explanation will be given in the following order.

1. Background

2. Embodiment
2.1. System configuration example
2.2. Functional configuration example of information processing terminal 10
2.3. Specific examples
   2.3.1. Dialogue control example 1
   2.3.2. Dialogue control example 2
   2.3.3. Dialogue control example 3
   2.3.4. Dialogue control example 4
   2.3.5. Dialogue control example 5
   2.3.6. Example of positive determination and negative determination
2.4. Operation examples
   2.4.1. Example of operation of voice authentication dialogue
   2.4.2. Example of generation of challenge speech string CSS
   2.4.3. Example of determination of hash seed word
   2.4.4. Example of voice authentication process including fake speech FCS

3. Hardware configuration example

4. Conclusion

### 1. Background

First, a background related to the present disclosure will be described. In recent years, an apparatus that performs a voice authentication process based on voice spoken by a user U has been developed. The voice authentication process here indicates an authentication process based on whether the user has spoken a predetermined phrase.

The voice authentication is used for various purposes. For example, the voice authentication may be used as an alternative means to user authentication based on input of identification information and a password at the time of use of a service on the Internet. Further, the voice authentication may be used as an alternative authentication means when the user U forgets the identification information or the password. Furthermore, the voice authentication may be used as an additional authentication means in two-step authentication. Moreover, the voice authentication may be used for identity verification when a user with visual impairment uses a service on the Internet.

Meanwhile, when the voice authentication is performed, and if a different person is present in a place where a speech of the user U can be heard, the different user may hear voice spoken by the user U and learn a predetermined phrase or the like of the user U. Further, even in authentication of the user U with visual impairment, if a different person is present near the user U when an apparatus reads information related to the authentication process, the different user may hear a speech of the user U and learn information related to the authentication process.

In contrast, if a volume of voice spoken by the apparatus is reduced or the apparatus does not read a part of information on the voice authentication in order to increase security strength, the user U may fail to hear or view necessary information.

The technical idea according to the present disclosure has been conceived in view of the foregoing points, and includes a function to perform a voice authentication process with certain security strength that is determined based on a situation of the user U. With this function, it is possible to perform the voice authentication process without imposing an excessive load on the user U and while adequately ensuring the security.

### 2. Embodiments

### 2.1. System Configuration Example

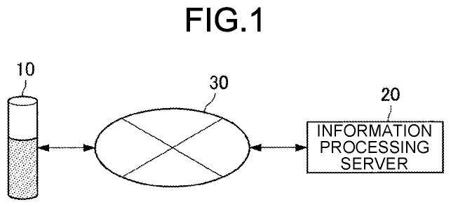

First, a system configuration example according to the present embodiment will be described with reference to FIG. 1. FIG. 1 is a diagram for explaining the system configuration example according to the present embodiment. An information processing system includes an information processing terminal 10, an information processing server 20, and a network 30.

Information Processing Terminal 10

The information processing terminal 10 is an information processing apparatus that controls a dialogue with a user and performs a voice authentication process based on a speech that is made by the user in the dialogue. Specifically, the information processing terminal 10 outputs a challenge speech CS to the user, and performs the voice authentication process on the basis of a response speech RS that is given from the user in response to the challenge speech CS. Here, the challenge speech CS is a speech that is output when the voice authentication process is performed by the information processing terminal 10. The information processing terminal 10 may generate a challenge speech string CSS related to the challenge speech CS by the information processing terminal 10 itself, or may issue a request to the information processing server 20 (to be described later). Details of the voice authentication process performed by the information processing terminal 10 will be described later.

Meanwhile, the information processing terminal 10 may be, for example, a smartphone, a tablet, a personal computer (PC), a smart speaker, a wearable device, a bearable device, or the like. Further, the information processing terminal 10 may be a stationary dedicated terminal or an autonomous mobile dedicated terminal. For example, the information processing terminal 10 may be an automatic teller machine (ATM) or a digital signage device.

Information Processing Server 20

The information processing server 20 generates a speech string related to the voice authentication process on the basis of a request from the information processing terminal 10. The speech string related to the voice authentication process is, for example, the challenge speech string CSS corresponding to the challenge speech CS. For example, the information processing server 20 may be a server capable of providing a general conversation dialogue service.

Network 30

The network 30 is a wired or wireless transmission channel between the information processing terminal 10 and the information processing server 20. For example, the network 30 may include a public line network, such as the Internet, a telephone network, or a satellite communication network, or various kinds of local area network (LAN) or wide area network (WAN) including Ethernet (registered trademark). Further, the network 30 may include a leased line network, such as Internet protocol-virtual private network (IP-VPN).

Thus, the configuration example of the information processing system according to the present embodiment has been described. Meanwhile, the configuration as described above with reference to FIG. 1 is one example, and the functional configuration of the information processing system according to the present embodiment is not limited thereto. The functional configuration of the information processing system according to the present embodiment may be flexibly modified depending on specifications or operation.

### 2.2. Functional Configuration Example of Information Processing Terminal 10

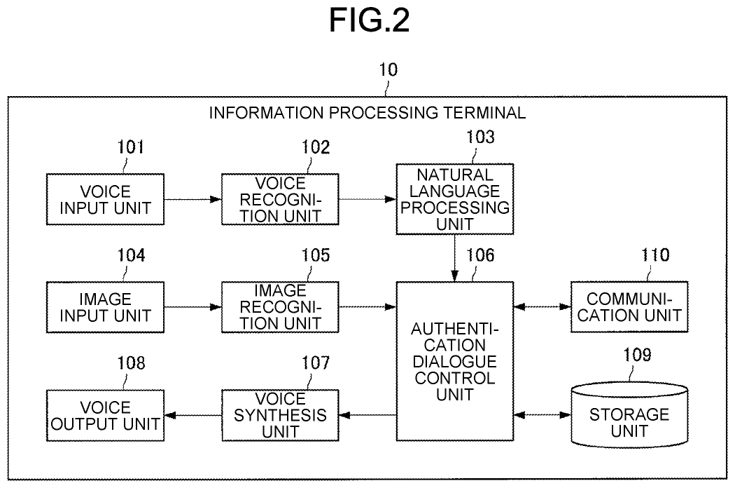

Next, an example of a functional configuration of the information processing terminal 10 according to the present embodiment will be described. FIG. 2 is a diagram for explaining an example of the functional configuration of the information processing terminal 10 according to the present embodiment. The information processing terminal 10 includes a voice input unit 101, a voice recognition unit 102, a natural language processing unit 103, an image input unit 104, an image recognition unit 105, an authentication dialogue control unit 106, a voice synthesis unit 107, a voice output unit 108, a storage unit 109, and a communication unit 110.

Voice Input Unit 101

The voice input unit 101 has a function to collect sound information, such as a speech made by a user. The sound information collected by the voice input unit 101 is used for a recognition process performed by the voice recognition unit 102 (to be described later). The voice input unit 101 includes a microphone for collecting the sound information.

Voice Recognition Unit 102

The voice recognition unit 102 has a function to perform an automatic voice recognition process based on the speech of the user collected by the voice input unit 101, and generates a speech string as a recognition result.

Natural Language Processing Unit 103

The natural language processing unit 103 has a function to perform a natural language understanding process on the result of the automatic voice recognition process performed by the voice recognition unit 102, and performs a process of adding, as an analysis result, a purpose of the speech, an attribute of a word, a concept, or the like to the speech string generated by the voice recognition unit 102. Specifically, the natural language processing unit 103 extracts, from the speech string recognized by the voice recognition unit 102, the purpose of the speech through a natural language understanding (NLU) process, an attribute of each of words included in the speech string through a morphological analysis process, a semantic concept of each of the words through reference to a word semantic concept dictionary, and the like. A result of the natural language process performed by the natural language processing unit 103 is used for the voice authentication process performed by the authentication dialogue control unit 106 (to be described later).

Image Input Unit 104

The image input unit 104 has a function to capture an image of a user and a surrounding situation. The image captured by the image input unit 104 is used to recognize the user or to recognize the surrounding situation by the image recognition unit 105 (to be described later). The image input unit 104 according to the present embodiment includes an image capturing device capable of capturing an image. Meanwhile, the image as described above includes a still image and a moving image.

Image Recognition Unit 105

The image recognition unit 105 has a function to perform various recognition processes based on the image captured by the image input unit 104. The image recognition unit 105 according to the present embodiment is able to recognize the user, the surrounding situation, and the like from the above-described image, for example. Here, the surrounding situation is, for example, a different person AP or the like who is present in the same place as the user U. A result of the recognition process performed by the image recognition unit 105 is used for the voice authentication process performed by the authentication dialogue control unit 106.

Authentication Dialogue Control Unit 106

The authentication dialogue control unit 106 has a function to control a dialogue with the user and performs the voice authentication process based on a speech that is made by the user in the dialogue. Specifically, the authentication dialogue control unit 106 generates the challenge speech string CSS, causes the voice output unit 108 to output the challenge speech string CSS as the challenge speech CS, and performs the voice authentication process on the basis of the response speech RS that is given from the user in response to the output challenge speech CS. Meanwhile, in the following, the voice authentication based on the challenge speech CS and the response speech RS may also be referred to as a voice authentication dialogue.

More specifically, the authentication dialogue control unit 106 performs, as the voice authentication process, determination on whether a response speech string RSS that is analyzed by the natural language processing unit 103 on the basis of the response speech RS that is given from the user in response to the challenge speech CS output by the voice output unit 108 includes a hash value word. If the response speech string RSS includes the hash value word, the authentication dialogue control unit 106 determines that voice authentication is successful.

The challenge speech string CSS may be a speech of a string by which a dialogue with the user U is possible. In contrast, the challenge speech string CSS may be a list of words.

The challenge speech CS includes a hash seed word that is defined in advance. The hash seed word may be determined from among a plurality of words that are defined in advance. Here, the hash value word is a word that has a predetermined relationship with the hash seed word under a word relation rule.

Here, the word relation rule is a predetermined rule that is defined between the hash seed word and the hash value word. The word relation rule is that, for example, a character or a syllable at a predetermined position in the hash seed word is the same as a character or a syllable at the predetermined position in the hash value word. The word relation rules is that, for example, the number of characters is the same between the hash seed word and the hash value word (or the number of characters of the hash value word is different from the number of characters of the hash seed word by a predetermined number) or the like. Further, the word relation rule is that, for example, the first or last vowel or consonant is the same between the hash seed word and the hash value word.

Furthermore, the hash seed word may have a hash seed attribute that is a predetermined attribute defined in advance, and the hash value word may include a hash value attribute that is a predetermined attribute defined in advance and for which a combination with a hash seed attribute is defined in advance. The hash seed attribute and the hash value attribute are attributes that respectively represent characteristics or features of a predetermined hash seed word and a predetermined hash value word.

In the following, a specific example will be described by using the hash seed attribute as an example. The same applies to the hash value attribute. For example, the hash seed attribute is a high-level concept of the hash seed word. If the hash seed attribute is the high-level concept of the hash seed word, for example, a hash seed attribute of a hash seed word of “apple” is “food”, and a hash seed attribute of a hash seed word of “dog” is an “animal”.

In addition, the hash seed attribute is, for example, a parse of the hash seed word. If the hash seed attribute is the parse of the hash seed word, for example, a hash seed attribute of a hash seed word of “cute” is an “adjective”, and a hash seed attribute of a hash seed word of “after” is a “conjunctive”.

Other examples of the hash seed attribute include a concept indicating that a word is a place-name, a personal name, or a content name (of a movie, music, a character, or the like), a word is a katakana word or a foreign word, or a word starts from a predetermined character. Further, the hash seed attribute may be, for example, personal data of the user. The personal data of the user is, for example, a contact information list, a schedule, or the like of the user, which is stored in the storage unit 109 (to be described later). Meanwhile, the authentication dialogue control unit 106 may perform the voice authentication process on the basis of whether the response speech string RSS complies with the word relation rule, without taking into account the hash seed attribute and the hash value attribute.

The authentication dialogue control unit 106 may generate the challenge speech string CSS including a hash seed word with a hash seed attribute that is defined in advance by the user U, and cause the voice output unit 108 to output the challenge speech string CSS as the challenge speech CS. Further, the authentication dialogue control unit 106 may determine whether the response speech string RSS, which is analyzed by the natural language processing unit 103 on the basis of the response speech RS given from the user, has a hash value attribute and includes a hash value word that complies with the word relation rule with respect to the hash seed word, and may determine that the voice authentication is successful if the hash value word is included.

In the determination as described above, the authentication dialogue control unit 106 may first determine whether the response speech string RSS includes a word with the hash value attribute, and if the response speech string RSS includes the word with the hash value attribute, the authentication dialogue control unit 106 may subsequently determine whether the response speech string RSS includes the hash value word on the basis of whether the word includes a word that meets the word relation rule.

A voice authentication dialogue by the authentication dialogue control unit 106 is started when, for example, the information processing terminal 10 detects a voice authentication start speech USS from the user U. Here, the voice authentication start speech USS is a speech of a predetermined phrase. Meanwhile, the voice authentication dialogue may be started on the basis of detection of the user U by the information processing terminal 10. For example, if the image recognition unit 105 recognizes the user U, the authentication dialogue control unit 106 may cause the voice output unit 108 to output the voice authentication start speech USS, such as “Good morning”, and start the voice authentication dialogue.

The authentication dialogue control unit 106 may combine other authentication, such as voice quality authentication or a gesture, in addition to the voice authentication as described above. For example, the authentication dialogue control unit 106 may determine that user authentication is successful if both of the voice authentication and the other authentication are successful. Alternatively, the authentication dialogue control unit 106 may perform the voice authentication as described above as an alternative authentication method to the other authentication.

The user U may define a plurality of combinations of the hash seed attribute, the hash value attribute, and the word relation rule as described above in advance. For example, if the authentication dialogue control unit 106 fails to the voice authentication, the authentication dialogue control unit 106 may perform the voice authentication again using a combination of a different hash seed attribute, a different hash value attribute, and a different word relation rule.

Meanwhile, the authentication dialogue control unit 106 is of course able to make a speech other than the challenge speech CS. For example, the authentication dialogue control unit 106 may make a speech for making a conversation with the user U. A specific example of the voice authentication process performed by the authentication dialogue control unit 106 will be described later.

Voice Synthesis Unit 107

The voice synthesis unit 107 has a function to synthesize voice under the control of the authentication dialogue control unit 106.

Voice Output Unit 108

The voice output unit 108 has a function to output various sounds including voice under the control of the authentication dialogue control unit 106. The voice output unit 108 outputs a speech, such as the challenge speech CS, related to the voice authentication. The voice output unit 108 includes, for example, a voice output device, such as a speaker or an amplifier.

Storage Unit 109

The storage unit 109 has a function to store therein information related to the voice authentication process performed by the authentication dialogue control unit 106. Examples of the information related to the voice authentication process include user personal data used for the voice authentication and a hash seed word database used for generation of the challenge speech string CSS. The user personal data is, for example, information, such as a place and a corresponding date written in a schedule of the user U or a family name and a first name in a contact information list of the user U, which is less likely to be recognized by the different person AP.

Communication Unit 110

The communication unit 110 has a function to perform communication with the information processing server 20 under the control of the authentication dialogue control unit 106. Specifically, the communication unit 110 transmits information for requesting generation of a speech string to the information processing server 20, and receives a generated speech string from the information processing server 20.

Thus, the functional configuration example of the information processing terminal 10 according to the present embodiment has been described above. Meanwhile, the configuration described above with reference to FIG. 2 is one example, and the functional configuration of the information processing terminal 10 according to the present embodiment is not limited to this example. The functional configuration of the information processing terminal 10 according to the present embodiment is flexibly modified depending on specifications or operation.

### 2.3. Specific Examples

### 2.3.1. Dialogue Control Example 1

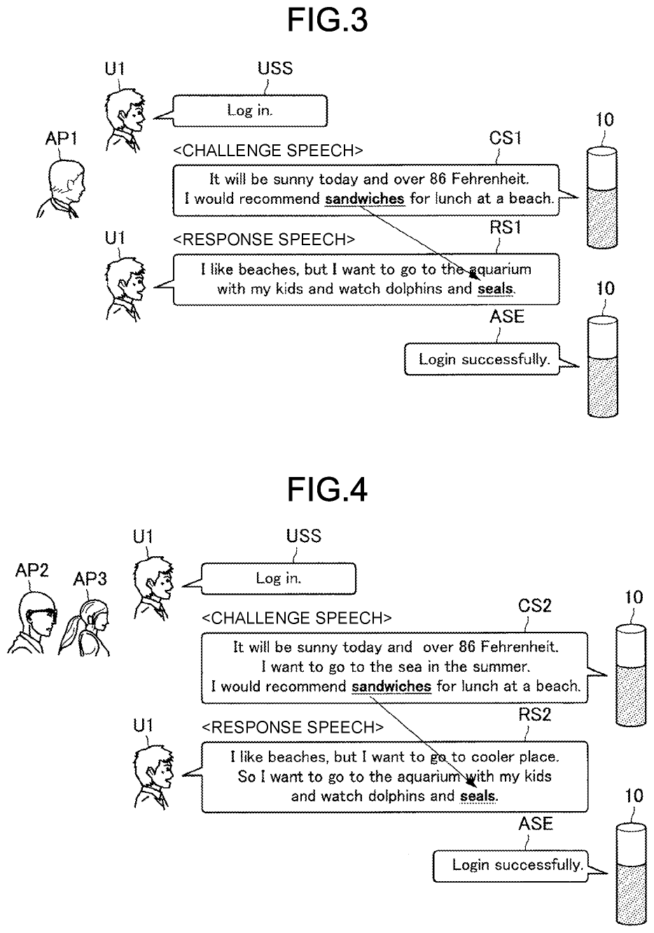

Specific examples of dialogue control performed by the authentication dialogue control unit 106 according to the present embodiment will be described below with reference to FIG. 3 to FIG. 11. As described above, the authentication dialogue control unit 106 determines security strength of the voice authentication process on the basis of presence of a different person recognized by the image recognition unit 105. The security strength described here is a level of difficulty for the different person to recognize a voice authentication method of the authentication dialogue control unit 106. Hereinafter, an example of the voice authentication process performed by the authentication dialogue control unit 106 on the basis of presence of a different person will be described.

FIG. 3 is a diagram for explaining an example of the voice authentication process performed by the authentication dialogue control unit 106 according to the present embodiment. In FIG. 3, a user U1 as a target for the voice authentication, a different person AP1, and the information processing terminal 10 are illustrated.

In the example in FIG. 3, in the information processing terminal 10, the user U1 defines that the hash seed attribute is “food”, the hash value attribute is an “animal”, and the word relation rule is that “the first character is the same between the hash seed word and the hash value word”. Therefore, the hash value word in the example in FIG. 3 is a word that has the same first character as that of the hash seed word with the attribute of “food”, and that has the attribute of an “animal”. Meanwhile, it is assumed that the same hash seed attribute, the same hash value attribute, and the same word relation rule are defined in specific examples to be described below with reference to FIG. 4 and subsequent figures, unless otherwise specified.

First, the user U gives the voice authentication start speech USS to start the voice authentication. The authentication dialogue control unit 106 starts the voice authentication process on the basis of the voice authentication start speech USS of the user analyzed by the natural language processing unit 103. Subsequently, the image input unit 104 captures an image of a situation of the user U1, and the image recognition unit 105 recognizes the different person. Then, the authentication dialogue control unit 106 generates a challenge speech string CSS1 including “sandwiches” with the attribute of “food” on the basis of presence of the different person AP1 recognized by the image recognition unit 105, and causes the voice output unit 108 to output a challenge speech CS1.

Subsequently, the user U1 gives a response speech RS1 including “seals” on the basis of the challenge speech CS1. Here, “seals” is a word that the user U1 has spoken on the basis of the word of “sandwiches” heard in the challenge speech CS1. The authentication dialogue control unit 106 detects “seals” that has the attribute of an “animal” and that has the first character of “s” from a response speech string RSS1 that is recognized from the response speech RS1 given by the user U1.

Then, the authentication dialogue control unit 106 determines that the response speech string RSS includes the hash value word on the basis of detection of “seals”, and determines that the voice authentication process is successful. Finally, the authentication dialogue control unit 106 causes the voice output unit 108 to output a voice authentication completion speech ASE indicating completion of the voice authentication, and the voice authentication process is terminated.

In this manner, by performing the voice authentication process using the challenge speech CS and the response speech RS, it is possible to make it difficult for a different person present in the same place to recognize voice authentication information.

Thus, an example of voice authentication dialogue control performed by the authentication dialogue control unit 106 when a different person is present has been described. Meanwhile, for example, it is expected that the probability that the voice authentication information is recognized by the different person increases with an increase in the number of different persons present in the same place as the the user U. In other words, it is necessary to increase the security strength of the voice authentication process with an increase in the number of different persons present in the same place as the user U. Therefore, if the image recognition unit 105 recognizes presence of different persons, the authentication dialogue control unit 106 may determine a length of the challenge speech string CSS to be generated, on the basis of the number of recognized different persons. Specifically, the authentication dialogue control unit 106 may increase the length of challenge speech string CSS to be generated with an increase in the number of recognized different persons.

An example of the voice authentication process based on the number of different persons recognized by the authentication dialogue control unit 106 will be described below with reference to FIG. 4. FIG. 4 is a diagram for explaining the example of the voice authentication process based on the number of different persons recognized by the authentication dialogue control unit 106 according to the present embodiment. In FIG. 4, the user U1 as a target for the voice authentication, different persons AP2 and AP3, and the information processing terminal 10 are illustrated.

First, the user U1 gives the voice authentication start speech USS to start the voice authentication. The authentication dialogue control unit 106 starts the voice authentication process on the basis of the voice authentication start speech USS of the user U1 analyzed by the natural language processing unit 103. Subsequently, the image input unit 104 captures an image of a situation of the user U1, and the image recognition unit 105 recognizes presence of the different persons AP2 and AP3. Here, the authentication dialogue control unit 106 recognizes that the number of the different persons AP is two (the number is increased as compared to one illustrated in FIG. 3).

Then, the authentication dialogue control unit 106 generates a challenge speech string CSS2 including a hash seed word of “sandwiches” on the basis of presence of the different persons AP2 and AP3 recognized by the image recognition unit 105, and causes the voice output unit 108 to output the challenge speech string CSS2 as a challenge speech CS2. Here, the challenge speech string CSS2 is a speech string longer than the challenge speech string CSS1 described with reference to FIG. 3.

Subsequently, the user U1 gives a response speech RS2 of a response speech string RSS2 including “seals” on the basis of the challenge speech CS2. The authentication dialogue control unit 106 detects “seals” that has the attribute of an “animal” from the response speech string RSS2 that is analyzed by the natural language processing unit 103 from the response speech string RSS2 that is recognized from the response speech RS2 of the user U1.

Then, the authentication dialogue control unit 106 determines that the response speech string RSS includes the hash value word, and determines that the voice authentication process is successful. Finally, the authentication dialogue control unit 106 causes the voice output unit 108 to output the voice authentication completion speech ASE indicating completion of the voice authentication, and the voice authentication process is terminated.

In this manner, by increasing the length of the challenge speech string CSS to be generated, it is possible to perform the voice authentication while maintaining the security even in a situation in which the number of different persons increases and the probability that the voice authentication information may be recognized increases. Further, the user U is able to recognize the number of different persons present in the same place by hearing the challenge speech CS.

### 2.3.2. Dialogue Control Example 2

In the above description, the example has been explained in which when a different person is present in the same place as the user U, the length of the challenge speech string CSS to be generated is changed depending on the number of different persons. Meanwhile, if a different person who was present in the same place as the user U1 during past voice authentication is present, the different person may guess the voice authentication information by additionally taking into account a past dialogue that was made between the user U and the information processing terminal 10. Further, in the same case as described above, the authentication dialogue control unit 106 may cause the voice output unit 108 to output a fake speech FCS in addition to the challenge speech CS at the time of the voice authentication dialogue. By mixing the challenge speech CS and the fake speech FCS, it becomes difficult for the different user to guess the voice authentication information. Here, the fake speech FCS is a speech for which a corresponding fake speech string FCSS does not include the hash seed word.

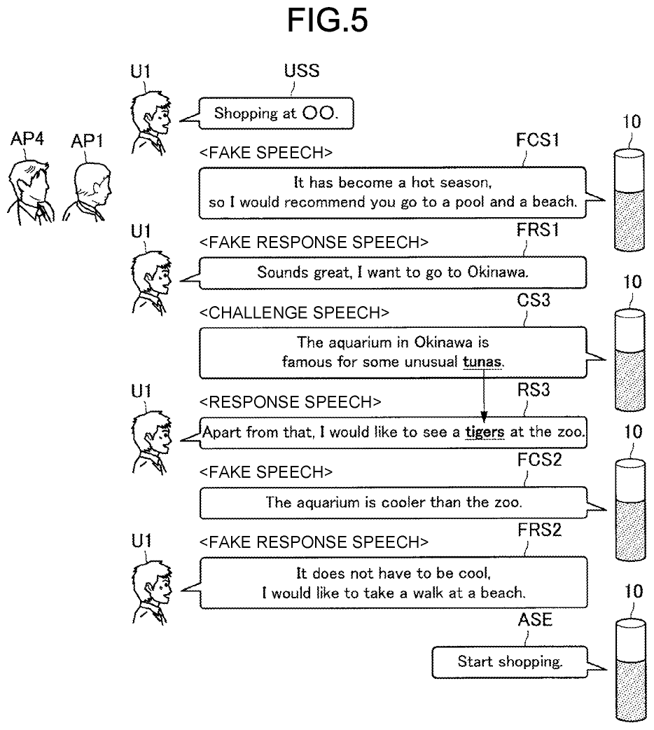

An example of voice authentication dialogue control including the fake speech FCS by the authentication dialogue control unit 106 will be described below with reference to FIG. 5. FIG. 5 is a diagram for explaining the example of the voice authentication dialogue control including the fake speech FCS by the authentication dialogue control unit 106 according to the present embodiment. In FIG. 5, the user U1 as a target for the voice authentication, the different person AP1, a different person AP4, and the information processing terminal 10 are illustrated. Here, the different person AP1 is a different person who was present in the same place during a past voice authentication process on the user U1.

For example, if the different person AP1 who was recognized in the same place as the user U during the past voice authentication process is present, the authentication dialogue control unit 106 may generate at least one fake speech string FCSS in addition to the challenge speech string CSS, and causes the voice output unit 108 to output the fake speech string FCSS as the fake speech FCS. The authentication dialogue control unit 106 causes the voice output unit 108 to output a next fake speech FCS or the challenge speech CS on the basis of recognition of a fake response speech FRS that is given from the user U in response to the output fake speech FCS. Meanwhile, the fake speech string FCSS may be a speech string that is naturally connected to the fake response speech FRS that is given from the user U in response to the response speech string RSS or the other fake speech string FCSS.

The example in FIG. 5 will be described below. First, the user U1 gives the voice authentication start speech USS to start the voice authentication. The authentication dialogue control unit 106 starts the voice authentication process on the basis of the voice authentication start speech USS of the user U1 analyzed by the natural language processing unit 103.

Subsequently, the image input unit 104 captures an image of a situation of the user U1, and the image recognition unit 105 recognize presence of different persons including the different person AP1 who was present in the same place during the past voice authentication process on the user U1. Then, the authentication dialogue control unit 106 generates a fake speech string FCSS1, and causes the voice output unit 108 to output the fake speech string FCSS1 as a fake speech FCS1. Subsequently, the user U1 gives a fake response speech FRS1 by speaking a fake response speech string FRSS1 based on the fake speech FCS1.

Then, the authentication dialogue control unit 106 generates a challenge speech string CSS3 including a hash seed word of “tunas” on the basis of the fake response speech FRS1 of the user U1, and causes the voice output unit 108 to output the challenge speech string CSS3 as a challenge speech CS3. The user U1 gives a response speech RS3 including “tigers” on the basis of the challenge speech CS3. The authentication dialogue control unit 106 detects “tigers” that has the hash value attribute of an “animal” and that complies with the word conversion rule, from a response speech string RSS3 that is recognized based on the response speech RS3. The authentication dialogue control unit 106 determines that the response speech string RSS3 includes the hash value word on the basis of detection of “tigers”, and determines that the voice authentication process is successful.

Subsequently, the authentication dialogue control unit 106 generates a fake speech string FCSS2, causes the voice output unit 108 to output the fake speech string FCSS2 as a fake speech FCS2. Then, the user U gives a fake response speech FRS2 by speaking a fake response speech string FRSS2 on the basis of the fake speech FCS2. Finally, the authentication dialogue control unit 106 causes the voice output unit 108 to output the voice authentication completion speech ASE indicating completion of the voice authentication, and the voice authentication process is terminated.

In this manner, by performing the voice authentication process using the fake speech FCS in addition to the challenge speech CS, it is possible to make it difficult to distinguish a speech that is used for the voice authentication in the dialogue between the user U and the information processing terminal 10.

Meanwhile, if a different person who was present in the same place as the user U during past voice authentication is present, the authentication dialogue control unit 106 may generate the challenge speech string CSS by using, as the hash seed word, a word that is different from a word used in the past voice authentication process. In this manner, by using, as the hash seed word, a word different from a word of the past voice authentication process, it is possible to prevent the voice authentication information from being guessed from appearance of the same word in the challenge speech CS.

In the above description, the example has been explained in which the authentication dialogue control unit 106 determines the length of the challenge speech string CSS to be generated, on the basis of the number of the recognized different persons AP. Similarly, the authentication dialogue control unit 106 may determine the number of the fake speech strings FCSS to be generated, that is, the number of the fake speeches FCS to be output by the voice output unit 108, on the basis of the number of the different persons AP recognized by the image recognition unit 105.

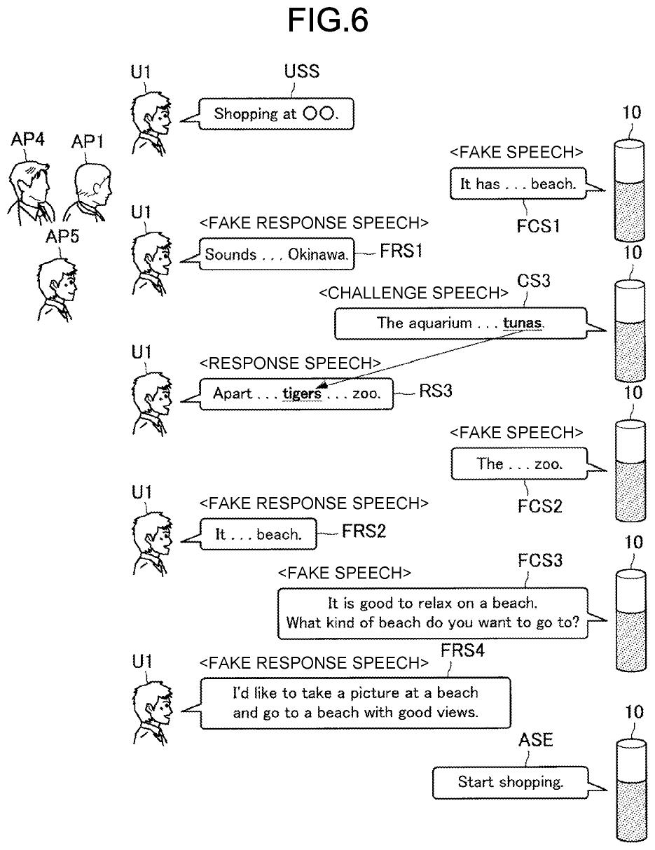

An example of voice authentication dialogue control including a certain number of the fake speeches FCS, where the number is determined based on the number of the different person AP by the authentication dialogue control unit 106 will be described below with reference to FIG. 6. FIG. 6 is a diagram for explaining the example of the voice authentication dialogue control including a certain number of the fake speeches FCS, where the number is determined based on the number of different persons by the authentication dialogue control unit 106 according to the present embodiment. In FIG. 6, the user U as a target for the voice authentication, the different persons AP1 and AP4, a different person AP5, and the information processing terminal 10 are illustrated. Here, the different person AP1 is a different person who was present in the same place during the past voice authentication process on the user U1, similarly to FIG. 5.

In the example in FIG. 6, the speeches from the voice authentication start speech USS to the fake response speech FRS2 of the user U1 are the same as the speeches as illustrated in FIG. 5, but the authentication dialogue control unit 106 gives a fake speech FCS3 after the fake response speech FRS2. The user U gives a fake response speech FRS3 on the basis of the fake speech FCS3. Finally, the authentication dialogue control unit 106 causes the voice output unit 108 to output the voice authentication completion speech ASE indicating completion of the voice authentication, and the voice authentication process is terminated.

In this manner, by determining the number of the fake speeches FCS on the basis of the number of the recognized different persons AP, it is possible to make it difficult to distinguish a speech that is used for the voice authentication difficult.

Thus, the example of the authentication dialogue including the fake speech FCS has been described above. In FIG. 5 and FIG. 6, the cases are explained in which the different person who was present in the same place during the past voice authentication is recognized, but, it is of course possible for the authentication dialogue control unit 106 to perform the dialogue control using the fake speech FCS even when only a different person who was not present during the past voice authentication is recognized.

### 2.3.3. Dialogue Control Example 3

Meanwhile, the voice authentication based on the response speech RS that is given from the user U1 in response to the challenge speech CS as described above is not always successful. For example, in some cases, a situation in which the user U1 is not able to associate the hash seed word with the hash seed word and the word relation rule or a situation in which the user may fail to hear a portion corresponding to the hash seed word in the challenge speech CS may occur.

The situations as described above may occur because the challenge speech string CSS corresponding to the output challenge speech CS is extremely long, or because a hash seed word with which it is difficult to associate the hash value word that complies with the word relation rule is selected, for example. In other words, the situations may occur due to generation of the challenge speech string CSS by which it is difficult for the user U1 to perform voice authentication successfully.

To cope with this, if the user U fails to speak a word that has the hash value attribute and that complies with the word relation rule in the response speech RS, the authentication dialogue control unit 106 may retry the voice authentication. Here, retry of the voice authentication is that, for example, the authentication dialogue control unit 106 goes back to a step of generating the challenge speech string CSS. The authentication dialogue control unit 106, when executing the challenge speech CS, may generate a shorter challenge speech string CSS than the challenge speech string CSS that was previously generated.

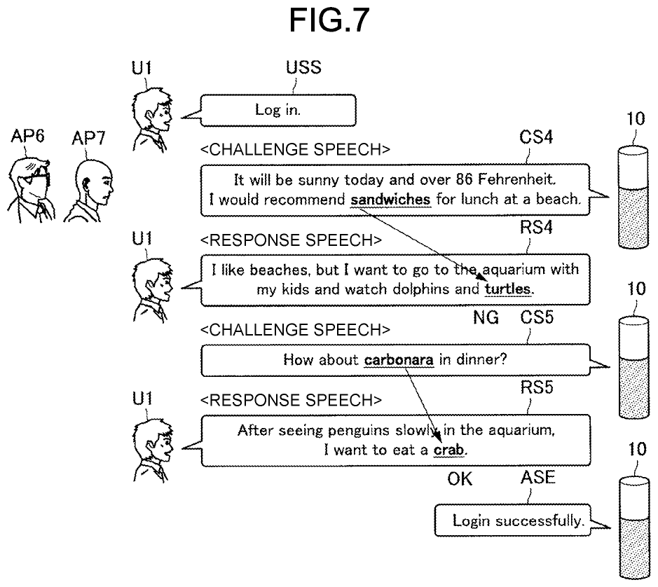

An example of the voice authentication process at the time of retry by the authentication dialogue control unit 106 will be described below with reference to FIG. 7. FIG. 7 is a diagram for explaining the example of the voice authentication process at the time of retry by the authentication dialogue control unit 106 according to the present embodiment. In FIG. 7, the user U1 as a target for the voice authentication, different persons AP6 and AP7, and the information processing terminal 10 are illustrated.

First, the user U1 gives the voice authentication start speech USS. The authentication dialogue control unit 106 of the information processing terminal 10 recognizes the voice authentication start speech USS and starts the voice authentication process. Subsequently, the image input unit 104 captures an image of a situation of the user U, and the image recognition unit 105 recognizes presence of the different persons AP6 and AP7. Then, the authentication dialogue control unit 106 generates a challenge speech string CSS4 including “sandwiches” on the basis of presence of the different persons recognized by the image recognition unit 105, and causes the voice output unit 108 to output the challenge speech string CSS4 as a challenge speech CS4.

Subsequently, the user U gives a response speech RS4 of a response speech string RSS4 including “turtles” on the basis of the challenge speech CS4. The authentication dialogue control unit 106 detects “turtles” that has the attribute of an “animal” from the response speech string RSS4 that is recognized from the response speech RS4 of the user U. Then, the authentication dialogue control unit 106 detects that the detected “turtles” is not a word that complies with the word relation rule. The authentication dialogue control unit 106 determines that the response speech string RSS does not include the hash value word, and determines that the voice authentication process is unsuccessful.

Subsequently, the authentication dialogue control unit 106 retries the voice authentication, generates a challenge speech string CSS5 including “carbonara”, and causes the voice output unit 108 to output the challenge speech string CSS5 as a challenge speech CS5. The challenge speech string CSS5 is a shorter speech string than the challenge speech string CSS4.

Then, the user U1 gives a response speech RS1 including “crab” on the basis of the challenge speech CS5. The authentication dialogue control unit 106 detects “crab” that has the attribute of an “animal” from a response speech string RSS1 recognized from the response speech RS1 of the user U1.

Subsequently, the authentication dialogue control unit 106 detects that the detected “crab” is a word that complies with the word relation rule. The authentication dialogue control unit 106 determines that the response speech string RSS includes the hash value word on the basis of detection of “crab”, and determines that the voice authentication process is successful. Finally, the authentication dialogue control unit 106 causes the voice output unit 108 to output the voice authentication completion speech ASE indicating completion of the voice authentication, and the voice authentication process is terminated.

In this manner, when the voice authentication is retried, by reducing the difficulty level of the voice authentication by reducing the length of the challenge speech string CSS, it is possible to perform the voice authentication with certain security strength appropriate for the user U.

In the above description, the example has been explained in which when the voice authentication is retried, the length of the challenge speech string CSS to be generated is reduced; however, it may be possible to increase the number of the hash seed words included in the challenge speech string CSS. By increasing the number of the hash seed words included in the challenge speech string CSS, it is possible to reduce the probability that the user U fails to hear all of portions corresponding to the hash seed word when hearing the challenge speech CS.

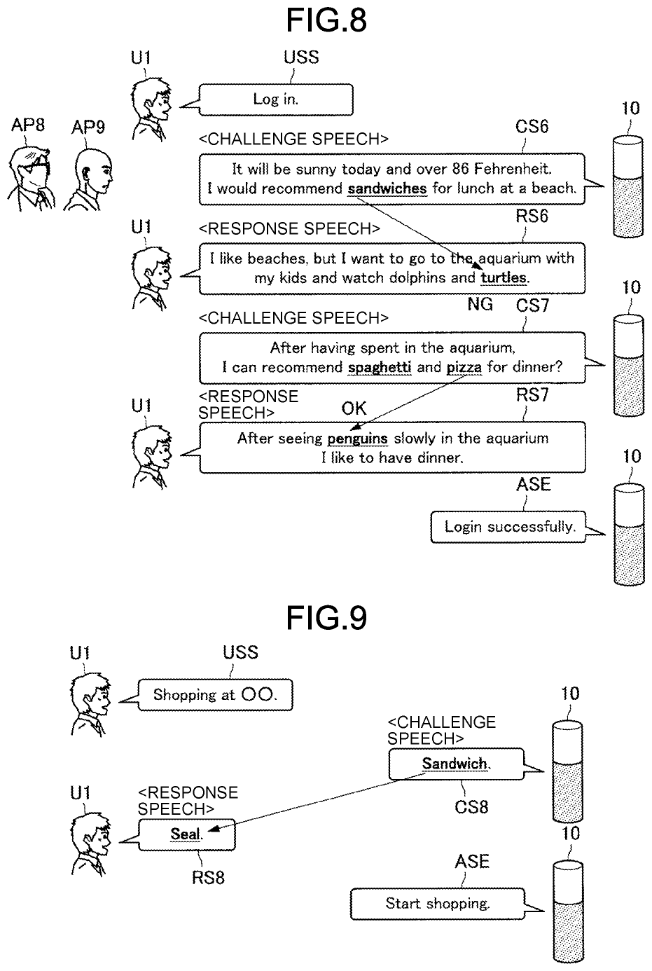

An example of the voice authentication process at the time of retry by the authentication dialogue control unit 106 will be described below with reference to FIG. 8. FIG. 8 is a diagram for explaining the example of the voice authentication process at the time of retry by the authentication dialogue control unit 106 according to the present embodiment. In FIG. 8, the user U1 as a target for the voice authentication, different persons AP8 and AP9, and the information processing terminal 10 are illustrated.

Here, speeches from the voice authentication start speech USS to a response speech RS6 are the same as the speeches from the voice authentication start speech USS to the response speech RS4 illustrated in FIG. 7.

Subsequently, the authentication dialogue control unit 106 retries the voice authentication, generates a challenge speech string CSS7 including “spaghetti” and “pizza”, and causes the voice output unit 108 to output the challenge speech string CSS7 as a challenge speech CS7. The challenge speech string CSS7 in this example is a speech that includes a larger number of hash seed words than the challenge speech string CSS5.

Then, the user U1 gives a response speech RS1 including “penguins” on the basis of the challenge speech CS5. The authentication dialogue control unit 106 detects “penguins” that has the attribute of an “animal” from a response speech string RSS1 that is recognized from the response speech RS1 of the user U.

Subsequently, the authentication dialogue control unit 106 detects that the detected “penguins” is a word that complies with the word relation rule. The authentication dialogue control unit 106 determines that the response speech string RSS includes the hash value word on the basis of detection of “penguins”, and determines that the voice authentication process is successful. Finally, the authentication dialogue control unit 106 causes the voice output unit 108 to output the voice authentication completion speech ASE indicating completion of the voice authentication, and the voice authentication process is terminated.

In this manner, when the voice authentication is retried, by reducing the difficulty level of the voice authentication by increasing the number of the hash seed words included in the challenge speech string CSS, it is possible to perform the voice authentication with certain security strength appropriate for the user U.

Meanwhile, the authentication dialogue control unit 106 may perform retry of the voice authentication a predetermined number of times at a maximum, and if the number of retries of the voice authentication exceeds the predetermined number, it may be possible to determine that the voice authentication is unsuccessful.

### 2.3.4. Dialogue Control Example 4

In the above description, the cases have been described in which a different person is present in the same place as the user U; however, in contrast, if a different person is not present in the same place as the user U, the probability that the voice authentication information is heard by a different person is low, and therefore, it may be possible to reduce the security strength of the voice authentication. For example, if the image recognition unit 105 does not recognize a different person, the authentication dialogue control unit 106 may cause the voice output unit 108 to output only the hash seed word as the challenge speech CS.

An example of the voice authentication process in a case in which the authentication dialogue control unit 106 does not recognize a different person will be described below with reference to FIG. 9. FIG. 9 is a diagram for explaining the example of the voice authentication process in the case in which the authentication dialogue control unit 106 according to the present embodiment does not recognize a different person. In FIG. 9, the user U1 as a target for the voice authentication and the information processing terminal 10 are illustrated.

First, the user U1 gives the voice authentication start speech USS. The authentication dialogue control unit 106 of the information processing terminal 10 recognizes the voice authentication start speech USS and starts the voice authentication process. Subsequently, the image input unit 104 captures an image of a situation of the user U1, and the image recognition unit 105 recognizes that a different person is absent. Then, the authentication dialogue control unit 106 generates a challenge speech string CSS8 including only a hash seed word of “Sandwich” on the basis of absence of a different person recognized by the image recognition unit 105, and causes the voice output unit 108 to output the challenge speech string CSS8 as a challenge speech CS8.

Subsequently, the user U1 gives a response speech RS8 including only “Seal” on the basis of the challenge speech CS8. Meanwhile, the response speech RS8 of the user U may be a speech based on a speech string that includes a word other than a hash value word as illustrated in FIG. 9. The authentication dialogue control unit 106 detects “Seal” that has the attribute of an “animal” from a response speech string RSS1 that is recognized from the response speech RS1 of the user U.

Then, the authentication dialogue control unit 106 detects that the detected “Seal” is a word that complies with the word relation rule. The authentication dialogue control unit 106 determines that the response speech string RSS includes the hash value word on the basis of detection of “Seal”, and determines that the voice authentication process is successful. Finally, the authentication dialogue control unit 106 causes the voice output unit 108 to output the voice authentication completion speech ASE indicating completion of the voice authentication, and the voice authentication process is terminated.

In this manner, if a different person is not present in the same place at the time of the voice authentication, by largely reducing the length of the challenge speech string CSS to be generated, it is possible to perform the voice authentication without imposing an excessive burden on the user U.

Meanwhile, in the example illustrated in FIG. 9, the challenge speech string CSS generated by the authentication dialogue control unit 106 includes only the hash seed word, but it is of course possible that the challenge speech string CSS includes a word other than the hash seed word.

### 2.3.5. Dialogue Control Example 5

In the above description, the examples have been explained in which the hash seed attribute and the hash value attribute are what is called “high-level concepts”, such as “food” and “animal”. However, the hash seed attribute and the hash value attribute may be determined on the basis of personal data of the user U, which is stored in the storage unit 109 of the information processing terminal 10, for example.

For example, the hash seed attribute may be determined as a “place written in a schedule of the user U” on the basis of the personal data of the user U, and the hash value attribute may be determined as a “date at which the place is written in the schedule”. In this case, the word relation rule is that “the place and the data written in the schedule match with each other”.

Further, as another example, the hash seed attribute may be a “family name of a person who is recorded in a contact information list of the user U”, the hash value attribute may be a “first name of the person who is recorded in the contact information list of the user U”, and the word relation rule may be that “the family name as the hash seed word and the first name as the hash value word match with each other (a combination of the family name and the first name is recorded in the contact information list of the user U)”.

By causing the authentication dialogue control unit 106 to perform the voice authentication process based on the personal data of the user U, it becomes difficult for a different person to guess the voice authentication information, so that it is possible to improve the security strength.

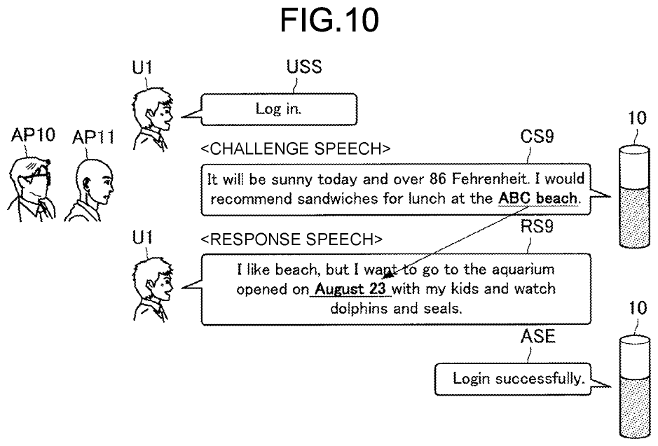

An example of the voice authentication process using user personal data by the authentication dialogue control unit 106 will be described with reference to FIG. 10. FIG. 10 is a diagram for explaining the example of the voice authentication process using the user personal data by the authentication dialogue control unit 106 according to the present embodiment. In FIG. 10, the user U1 as a target for the voice authentication, different persons AP10 and AP11, and the information processing terminal 10 are illustrated.

First, the user U1 gives the voice authentication start speech USS. The authentication dialogue control unit 106 starts the voice authentication process on the basis of the voice authentication start speech USS of the user analyzed by the natural language processing unit 103. Subsequently, the image input unit 104 captures an image of a situation of the user U, and the image recognition unit 105 recognizes presence of the different persons AP10 and AP11. Then, the authentication dialogue control unit 106 generates the challenge speech string CSS on the basis of presence of the different persons AP10 and AP11 recognized by the image recognition unit 105, and causes the voice output unit 108 to output a challenge speech CS9 including “ABC beach” that has the attribute of a “place written in a schedule of the user U1”.

Subsequently, the user U1 gives a response speech RS9 including “August 23” that is a date at which “ABC beach” is written in the schedule on the basis of the challenge speech CS9. The authentication dialogue control unit 106 detects “August 23” that is a “date at which the place is written in the schedule” from a response speech string RSS9 that is recognized from the response speech RS9 of the user U.

Subsequently, the authentication dialogue control unit 106 detects that “August 23” complies with the word relation rule, that is, “ABC beach” is written at this date. The authentication dialogue control unit 106 determines that the response speech string RSS includes the hash value word on the basis of detection of “August 23”, and determines that the voice authentication process is successful. Finally, the authentication dialogue control unit 106 causes the voice output unit 108 to output the voice authentication completion speech ASE indicating completion of the voice authentication, and the voice authentication process is terminated.

In this manner, by using the personal data of the user U that is difficult for a different person to recognize, it is possible to perform the voice authentication with increased security strength.

Thus, the voice authentication process that is performed with security strength corresponding to the situation of the user by the authentication dialogue control unit 106 has been described above. In the examples as described above, the security strength is determined on the basis of the number of different persons or presence of a different person who was present in the same place as the user U during past voice authentication, but a method of determining the security strength is not limited to this example. For example, the authentication dialogue control unit 106 may determine the security strength of the voice authentication on the basis of attention of a different person. Here, the attention of the different person is a degree of interest in the user U or the information processing terminal 10 on the basis of a line of sight or a face orientation of the different person, for example. If a different person who is interested in the user U or the information processing terminal 10 is present, the authentication dialogue control unit 106 may increase the security strength of the voice authentication.

Furthermore, the authentication dialogue control unit 106 may change the difficulty level of the voice authentication dialogue, that is, the security strength, in accordance with a service that the user U wants to start to use. Moreover, the authentication dialogue control unit 106 may change quality of voice to be output by the voice output unit 108 in accordance with a combination of the hash seed attribute, the hash value attribute, and the word relation rule. Meanwhile, the authentication dialogue control unit 106 may perform the authentication process as described above by inputting and outputting a sentence to and from the user U.

### 2.3.6. Example of Positive and Negative Determination

Specific examples of the voice authentication process corresponding to presence or absence of a different person who is present in the same place as the user U have been described above. Meanwhile, in the voice authentication, if a dialogue that is made between the information processing terminal 10 and the user U is a natural conversation for a different person, it becomes difficult to learn a timing at which the voice authentication information is exchanged during the dialogue.

Therefore, for example, the information processing terminal 10 may perform positive determination or negative determination on the fake response speech string FRSS, which is recognized on the basis of the fake response speech FRS that is given by the user in response to the output fake speech FCS, with respect to the fake speech FCS.

Here, the positive determination or the negative determination is used to generate the challenge speech string CSS and the fake speech string FCSS. By performing the positive determination or the negative determination on the fake response speech string FRSS with respect to the fake speech FCS, it becomes easy to predict a response of the user to the challenge speech CS or the fake speech FCS, and it is possible to make a more natural dialogue.

Specifically, the natural language processing unit 103 may detect a positive word, a negative word, or a word group included in the fake response speech string FRSS that is recognized from the fake response speech FRS of the user U, and the authentication dialogue control unit 106 may perform the positive determination or the negative determination on the basis of the word or the word group.

For example, the natural language processing unit 103 may calculate a score of the positive word, the negative word, or the word group included in the fake response speech string FRSS that is recognized from the fake response speech FRS of the user U. Further, for example, the authentication dialogue control unit 106 may perform the positive determination or the negative determination on the basis of whether the score calculated by the natural language processing unit 103 is equal to or larger than a predetermined value or equal to or smaller than a predetermined value. For example, the authentication dialogue control unit 106 may determine a score of the fake response speech string FRSS in a range from −1.0 to +1.0, perform the negative determination if the score is equal to or smaller than −0.5, and perform the positive determination if the score is equal to or larger than +0.5.

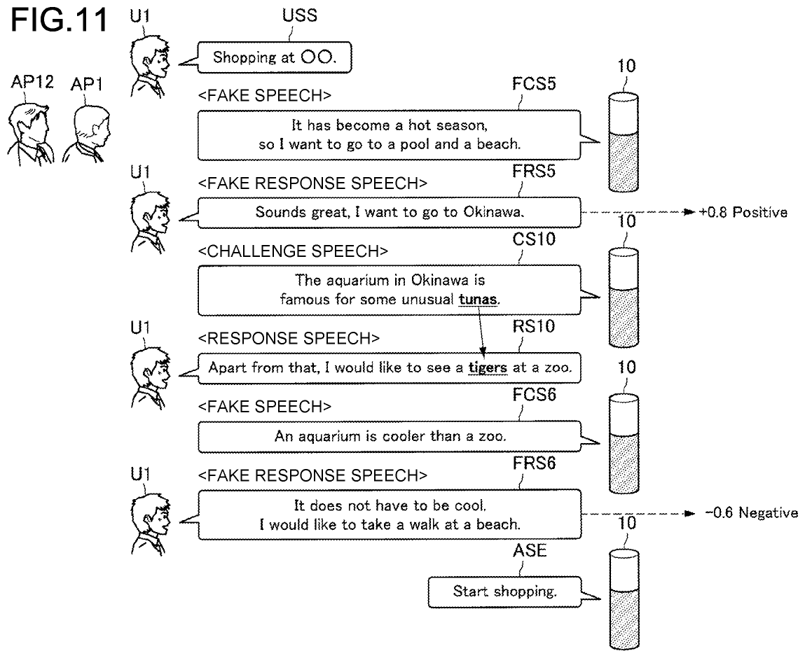

An example of the positive determination and the negative determination on the fake response speech string FRSS with respect to the fake speech FCS by the authentication dialogue control unit 106 according to the present embodiment will be described with reference to FIG. 11. FIG. 11 is a diagram for explaining the example of the positive determination and the negative determination on the fake response speech string FRSS with respect to the fake speech FCS by the authentication dialogue control unit 106 according to the present embodiment. In FIG. 11, the user U1 as a target for the voice authentication, the different person AP1, a different person AP12, and the information processing terminal 10 are illustrated.

The voice authentication start speech USS, speeches from a fake speech FCS5 to a fake response speech FRS6, and the voice authentication completion speech ASE are the same as the voice authentication start speech USS, the speeches from the fake speech FCS1 to the fake response speech FRS2, and the voice authentication completion speech ASE as illustrated in FIG. 5. Here, the authentication dialogue control unit 106 performs the positive determination or the negative determination on the basis of the score that is calculated by the natural language processing unit 103 for a fake response speech string FRSS5 by which a fake response speech FRS5 is recognized.

Specifically, the natural language processing unit 103 calculates a score of “+0.8” with respect to the fake response speech string FRSS5, and the authentication dialogue control unit 106 performs the positive determination on the fake response speech string FRSS5 on the basis of the score. Further, the natural language processing unit 103 calculates a score of “−0.6” with respect to the fake response speech string FRSS5, and the authentication dialogue control unit 106 performs the negative determination with respect to the fake response speech string FRSS5 on the basis of the score. Determination results may be stored in the storage unit 109 or may be transmitted to the information processing server 20.

In this manner, by accumulating data on the positive determination or the negative determination on the fake response speech string FRSS with respect to the fake speech FCS and using the data to generate a speech string, it is possible to more naturally perform a dialogue with the user U.

While the case has been described in the example in FIG. 11 in which the authentication dialogue control unit 106 performs the positive determination or the negative determination on the fake response speech FRS, it is of course possible to perform the same determination on the response speech RS with respect to the challenge speech CS. Further, even in a case in which two or more different persons are present or no different person is present, it is possible to perform the same determination.

### 2.4. Operation Examples

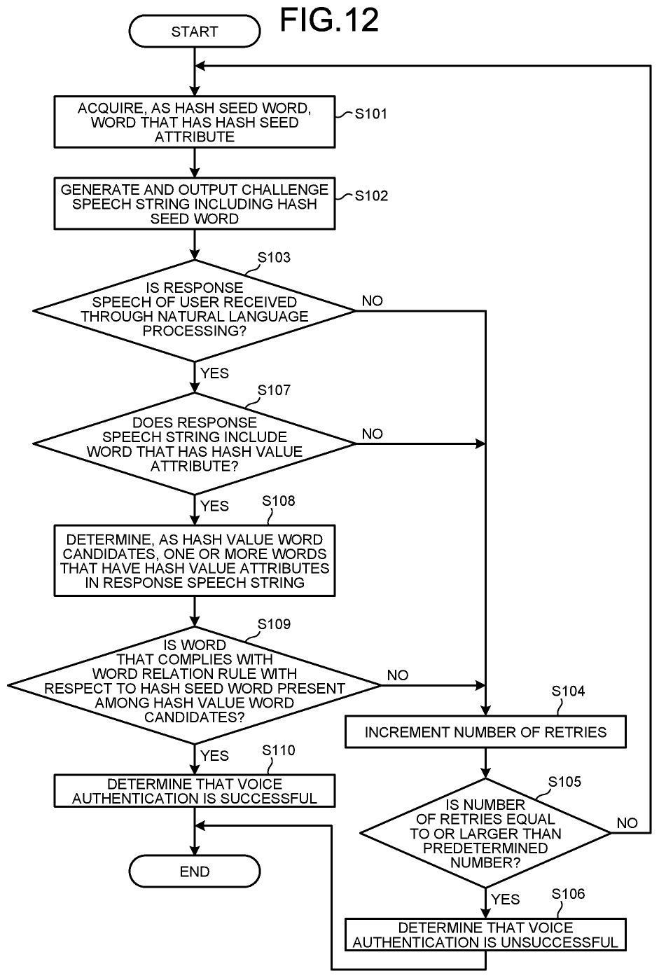

Examples of the flow of operation of the voice authentication dialogue control performed by the authentication dialogue control unit 106 according to the present embodiment will be described below with reference to FIG. 12 to FIG. 15.

### 2.4.1. Example of Operation of Voice Authentication Dialogue

First, an example of the flow of operation of a process related to the voice authentication based on output of the challenge speech CS and the response speech RS by the authentication dialogue control unit 106 according to the present embodiment will be described with reference to FIG. 12. FIG. 12 is a diagram for explaining an example of the flow of the operation of the process related to the voice authentication based on output of the challenge speech CS and the response speech RS by the authentication dialogue control unit 106 according to the present embodiment.

With reference to FIG. 12, first, if the voice authentication start speech USS from the user U is recognized, the authentication dialogue control unit 106 acquires a word that has the hash seed attribute from the storage unit 109 (S101). At Step S101, the authentication dialogue control unit 106 may acquire a word that has the hash seed attribute from the information processing server 20. Subsequently, the authentication dialogue control unit 106 generates the challenge speech string CSS including the hash seed word acquired at Step S101, and causes the voice output unit 108 to output the challenge speech string CSS as the challenge speech CS (S102).

Subsequently, if the response speech string RSS that is subjected to the natural language process is not received from the natural language processing unit 103 (S103: No), the authentication dialogue control unit 106 increments the number of retries (S104). Further, if the number of retries is equal to or larger than a predetermined number (S105: Yes), the authentication dialogue control unit 106 determines that the voice authentication is unsuccessful (S106), and the authentication dialogue control unit 106 terminates the operation. In contrast, if the number of retries is not equal to or larger than the predetermined number (S105: No), the process returns to Step S101.

In contrast, if the response speech string RSS that is subjected to the natural language process is received from the natural language processing unit 103 (S103: Yes), and the response speech string RSS does not include a word that has the hash value attribute (S107: No), the process proceeds to Step S104. In contrast, if the response speech string RSS that is subjected to the natural language process is received from the natural language processing unit 103 (S103: Yes), and the response speech string RSS includes one or more words that have the hash value attributes (S107: Yes), the authentication dialogue control unit 106 determines that the words that are included in the response speech string RSS and that have the hash value attributes as hash value word candidates (S108).

Subsequently, if a word that complies with the word relation rule with respect to the hash seed word is not present among the hash value word candidates determined at Step S108 (S109: No), the process proceeds to Step S104. In contrast, if a word that complies with the word relation rule with respect to the hash seed word is present among the hash value word candidates determined at Step S108 (S109: Yes), the authentication dialogue control unit 106 determines that the voice authentication is successful (S110), and the authentication dialogue control unit 106 terminates the operation.

### 2.4.2. Example of Generation of Challenge Speech String CSS

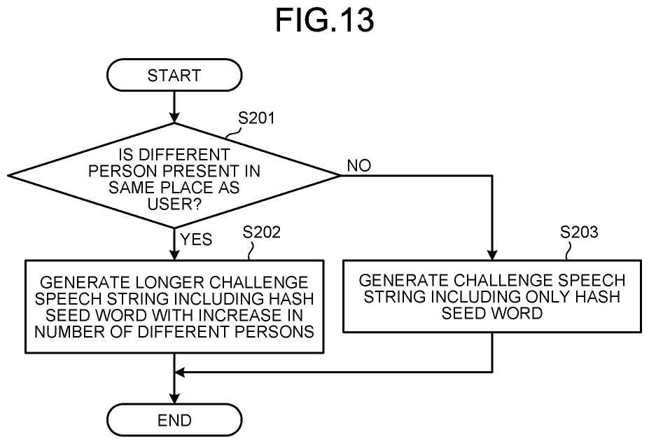

An example of the flow of a process of generating the challenge speech string CSS by the authentication dialogue control unit 106 according to the present embodiment will be described below with reference to FIG. 13. FIG. 13 is a diagram for explaining the example of the process of generating the challenge speech string CSS by the authentication dialogue control unit 106 according to the present embodiment.

With reference to FIG. 13, first, if a different person is present in the same place as the user U (S201: Yes), the authentication dialogue control unit 106 generates a longer challenge speech string CSS with an increase in the number of recognized different persons (S202), and the authentication dialogue control unit 106 terminates the operation. In contrast, if a different person is not present in the same place as the user U (S201: No), the authentication dialogue control unit 106 generates the challenge speech string CSS including only the hash seed word (S203), and the authentication dialogue control unit 106 terminates the operation. Meanwhile, at Step S203, the authentication dialogue control unit 106 may generate the challenge speech string CSS that includes a smaller number of words than the challenge speech string CSS generated at Step S202 and that includes a word other than the hash seed word.

### 2.4.3. Example of Determination of Hash Seed Word

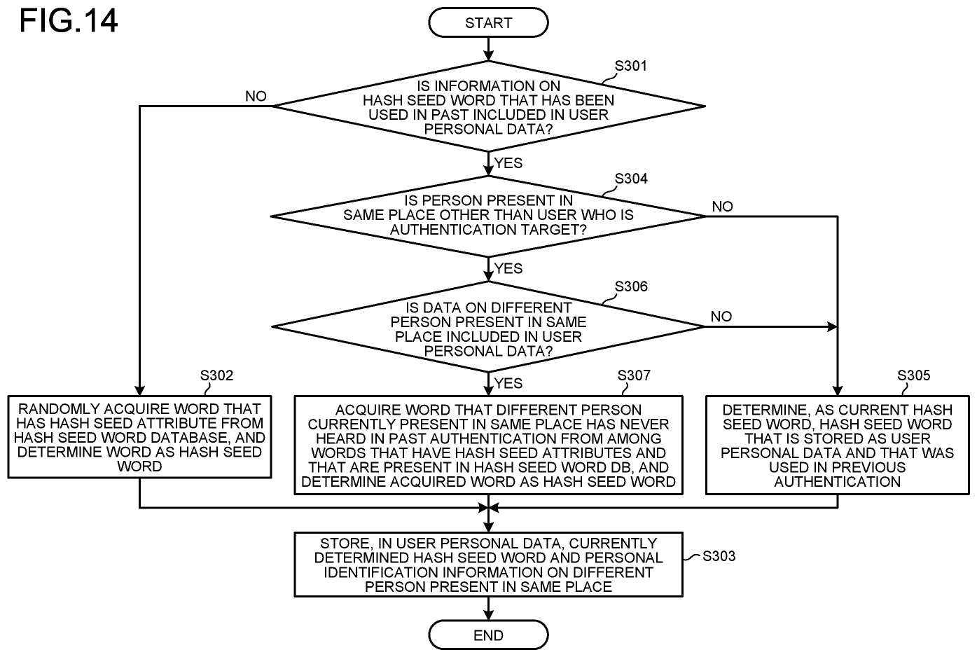

An example of the flow of a process of determining the hash seed word by the authentication dialogue control unit 106 according to the present embodiment will be described below with reference to FIG. 14. FIG. 14 is a diagram for explaining the example of the flow of the process of determining the hash seed word by the authentication dialogue control unit 106 according to the present embodiment.

With reference to FIG. 14, first, if information on the hash seed word that has been used in the past is not included in user personal data (S301: No), the authentication dialogue control unit 106 randomly learns a word that has the hash seed attribute from the hash seed word database stored in the storage unit 109, and determines the word as the hash seed word (S302). Subsequently, the authentication dialogue control unit 106 stores the hash seed word determined at Step S302 and information on a different person who is present in the same place as the user U as the user personal data in the storage unit 109 (S303), and the authentication dialogue control unit 106 terminates the operation.

In contrast, if information on the hash seed word that has been used in the past is included in the user personal data (S301: Yes), and a different person is not present in the same place other than the user U who is an authentication target (S304: No), the authentication dialogue control unit 106 determines, as a hash seed word to be used at this time, a hash seed word that is stored as the user personal data and that was used in previous authentication (S305). Subsequently, the authentication dialogue control unit 106 stores the hash seed word determined at Step S305 and information on a different person who is present in the same place as the user U in the user personal data in the storage unit 109 (S303), and the authentication dialogue control unit 106 terminates the operation.

In contrast, if a different person is present in the same place other than the user U who is the authentication target (S304: Yes), and information on the currently recognized different person is not stored in the user personal data (S306: No), the process proceeds to Step S305.

Furthermore, if the information on the currently recognized different person is not stored in the user personal data (S306: Yes), the authentication dialogue control unit 106 acquires a word that the different person who is currently present in the same place as the user U has never heard in the voice authentication on the user U from among words that have the hash seed attributes and that are present in the hash seed word database stored in the storage unit 109, and determines the acquired word as the hash seed word (S307). Subsequently, the authentication dialogue control unit 106 stores the hash seed word determined at Step S307 and information on a different person who is present in the same place as the user U as the user personal data in the storage unit 109 (S303), and the authentication dialogue control unit 106 terminates the operation.

### 2.4.4. Example of Voice Authentication Process Including Fake Speech FCS

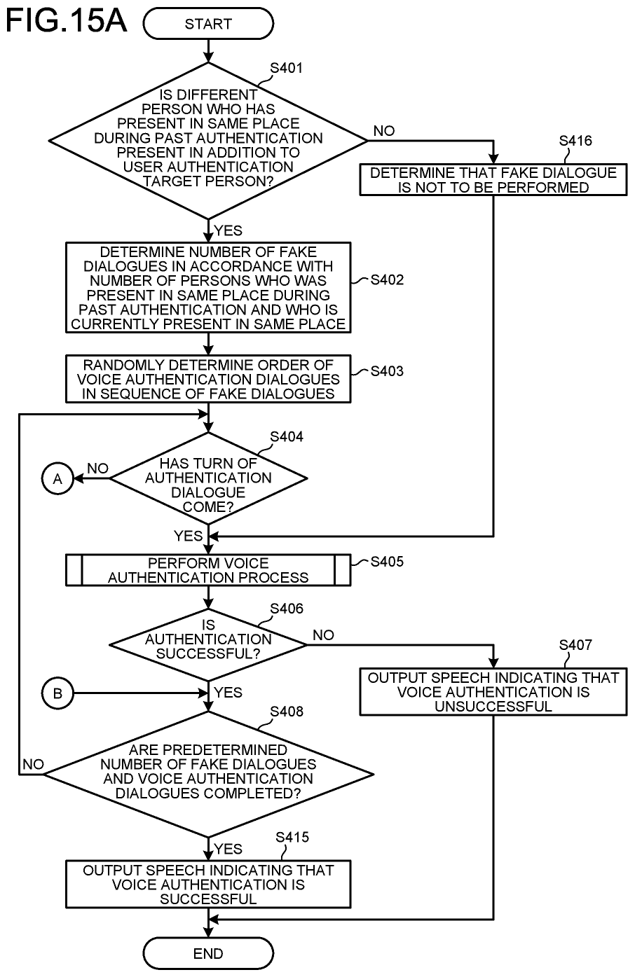

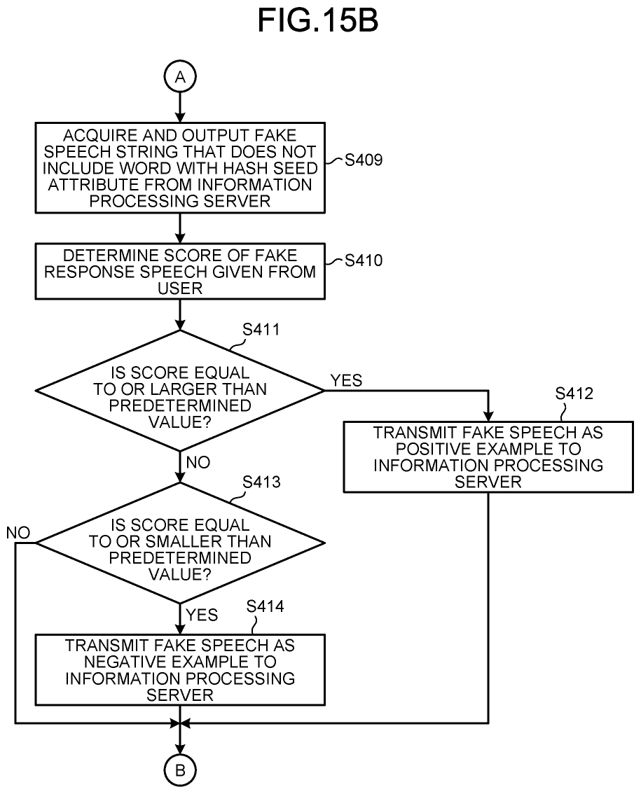

An example of the flow of operation of a process related to voice authentication that includes the fake speech FCS and that is performed by the authentication dialogue control unit 106 according to the present embodiment will be described below with reference to FIG. 15A and FIG. 15B. FIG. 15A and FIG. 15B are diagrams for explaining the example of the flow of operation of a process related to voice authentication that includes the fake speech FCS and that is performed by the authentication dialogue control unit 106 according to the present embodiment.

With reference to FIG. 15A, first, if a different person who was present in the same place as the user U during past voice authentication is present in addition to the user U (S401: Yes), the authentication dialogue control unit 106 determines the number of the fake speeches FCS on the basis of the number of different persons who was present in the same place as the user U during the past voice authentication (S402). Subsequently, the authentication dialogue control unit 106 randomly determines the order of the challenge speeches CS and the fake speeches FCS (S403).

Subsequently, if a turn of a voice authentication dialogue for making the challenge speech CS has come in the order of speeches determined at Step S403 (S404: Yes), the authentication dialogue control unit 106 performs the voice authentication process (S405). Here, the voice authentication process at Step S405 is a process related to the voice authentication dialogue control for which the example is illustrated in FIG. 12.

Then, if the voice authentication is unsuccessful at Step S405 (S406: No), the authentication dialogue control unit 106 causes the voice output unit 108 to output a speech indicating that the voice authentication is unsuccessful (S407), and the authentication dialogue control unit 106 terminates the operation. Furthermore, in contrast, if the voice authentication is successful at Step S405 (S406: Yes), and if the predetermined number of fake dialogues and voice authentication dialogues as determined at Step S402 are completed (S408: Yes), the authentication dialogue control unit 106 causes the voice output unit 108 to output a speech indicating that the voice authentication is successful (S415), and the authentication dialogue control unit 106 terminates the operation. In contrast, if the predetermined number of fake dialogues and voice authentication dialogues as determined at Step S402 are not completed (S408: No), the process returns to Step S404.

Moreover, in contrast, if a turn of the voice authentication dialogue for making the challenge speech CS has not yet come in the order of speeches determined at Step S403 (S404: No), with reference to FIG. 15B, the authentication dialogue control unit 106 acquires the fake speech string FCSS that does not include a word with the hash seed attribute from the information processing server 20, gives the fake speech FCS, and causes the voice output unit 108 to output the fake speech FCS (S409). Then, the natural language processing unit 103 calculates a score of the fake response speech string FRSS given from the user U (S410).

Subsequently, if the score calculated at Step S410 is equal to or larger than a predetermined value (S411: Yes), the authentication dialogue control unit 106 transmits the fake response speech FRS as a positive example (performs positive determination) to the information processing server 20 (S412), and proceeds to Step S408 illustrated in FIG. 15A.

In contrast, if the score calculated at Step S410 is not equal to or larger than the predetermined value (S411: No), and the score calculated at Step S410 is equal to or smaller than a predetermined value (S413: Yes), the authentication dialogue control unit 106 transmits the fake response speech FRS as a negative example (performs negative determination) to the information processing server 20 (S414), and proceeds to Step S408 illustrated in FIG. 15A. In contrast, if the score calculated at Step S410 is not equal to or smaller than the predetermined value (S413: No), the process proceeds to Step S408 illustrated in FIG. 15A.

Meanwhile, if a different person who was present in the same place as the user U during the past voice authentication is not present in addition to the user U (S401: No), the authentication dialogue control unit 106 determines that a fake dialogue is not to be performed, that is, determines that the number of fake dialogues is zero (S416), and proceeds to Step S405.

### 3. Hardware Configuration Example

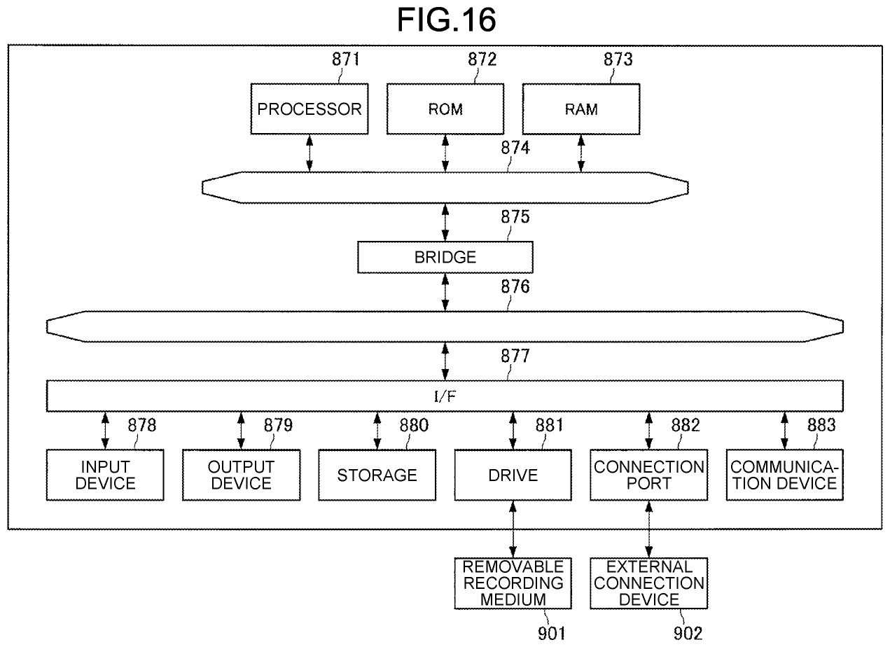

A hardware configuration example common to the information processing terminal 10 and the information processing server 20 according to one embodiment of the present disclosure will be described below. FIG. 16 is a block diagram illustrating an example of the hardware configuration of the information processing terminal 10 and the information processing server 20 according to one embodiment of the present disclosure. With reference to FIG. 16, each of the information processing terminal 10 and the information processing server 20 includes, for example, a processor 871, a read only memory (ROM) 872, a random access memory (RAM) 873, a host bus 874, a bridge 875, an external bus 876, an interface 877, an input device 878, an output device 879, a storage 880, a drive 881, a connection port 882, and a communication device 883. Meanwhile, the hardware configuration described here is one example, and a part of the structural elements may be omitted. Further, it may be possible to include other structural elements in addition to the structural elements described herein.

Processor 871

The processor 871 functions as, for example, an arithmetic processing device or a control device, and controls the entire operation or a part of the operation of each of the structural elements on the basis of various programs recorded in the ROM 872, the RAM 873, the storage 880, or a removable recording medium 901.

ROM 872 and RAM 873

The ROM 872 is a means for storing a program to be read by the processor 871, data used for calculations, and the like. The RAM 873 temporarily or permanently stores therein, for example, a program to be read by the processor 871, various parameters that are appropriately changed when the program is executed, and the like. The processor 871, the ROM 872, and the RAM 873 implement the functions of the authentication dialogue control unit 106, the voice recognition unit 102, the natural language processing unit 103, the image recognition unit 105, and the voice synthesis unit 107.

Host Bus 874, Bridge 875, External Bus 876, and Interface 877

The processor 871, the ROM 872, and the RAM 873 are connected to one another via, for example, the host bus 874 capable of transferring data at a high speed. In contrast, the host bus 874 is connected to, for example, the external bus 876 with a relatively low data transfer speed via the bridge 875. Further, the external bus 876 is connected to various structural elements via the interface 877.

Input Device 878

As the input device 878, for example, a mouse, a keyboard, a touch panel, a button, a switch, a lever, or the like is used. Further, as the input device 878, a remote controller (hereinafter, may be referred to as a remote) capable of transmitting a control signal by using infrared or other radio waves may be used. Furthermore, the input device 878 includes a voice input device, such as a microphone. The input device 878 implements the functions of the voice input unit 101 and the image input unit 104.

Output Device 879

The output device 879 is a device, such as a display device including a cathode ray tube (CRT), a liquid crystal display (LCD), or an organic electroluminescence (EL), an audio output device including a speaker or a headphone, a printer, a mobile phone, or a facsimile machine, which is able to visually or auditorily notify a user of acquired information. Further, the output device 879 according to the present disclosure includes various vibration devices capable of outputting tactile stimulation. The output device 879 implements the functions of the voice output unit 108.

Storage 880

The storage 880 is a device for storing various kinds of data. As the storage 880, for example, a magnetic storage device, such as a hard disk drive (HDD), a semiconductor storage device, an optical storage device, a magneto optical storage device, or the like may be used.

Drive 881

The drive 881 is a device that reads information stored in the removable recording medium 901, such as a magnetic disk, an optical disk, a magneto optical disk, or a semiconductor memory, or writes information to the removable recording medium 901.

Removable Recording Medium 901

The removable recording medium 901 is, for example, a digital versatile disk (DVD) medium, a Blu-ray (registered trademark) medium, an HD DVD medium, various semiconductor storage media, or the like. The removable recording medium 901 may of course be, for example, an integrated circuit (IC) card with a contactless IC chip, an electronic device, or the like. The storage 880, the drive 881, the removable recording medium 901, and the like implement the functions of the storage unit 109.

Connection Port 882

The connection port 882 is, for example, a universal serial bus (USB) port, an IEEE1394 port, a small computer system interface (SCSI), an RS-232C port, a port for connecting an external connection device 902, such as an optical terminal, or the like.

External Connection Device 902

The external connection device 902 is, for example, a printer, a portable music player, a digital camera, a digital video camera, an IC recorder, or the like.

Communication Device 883

The communication device 883 is a communication device for establishing a connection to a network, and is, for example, a communication card for a wired or wireless LAN, Bluetooth (registered trademark), or a wireless USB (WUSB), a router for optical communication, a router for asymmetric digital subscriber line (ADSL), a modem for various kinds of communication, or the like. The communication device 883 implements the functions of the communication unit 110.

### 4. Conclusion

Thus, as described above, the information processing system according to the present embodiment has a function to perform a voice authentication process with security strength that is determined based on a situation of a user. With this function, it is possible to perform the voice authentication process without imposing an excessive load on the user while ensuring adequate security.

While the preferred embodiments of the present disclosure have been described in detail above with reference to the accompanying drawings, the technical scope of the present disclosure is not limited to the examples as described above. It is obvious that a person skilled in the technical field of the present disclosure may conceive various alternations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the following configurations are also within the technical scope of the present disclosure.

(1)

An information processing apparatus comprising:

an authentication dialogue control unit that controls a dialogue with a user and performs a voice authentication process based on a speech that is made by the user in the dialogue, wherein

the authentication dialogue control unit generates a challenge speech string including a hash seed word, outputs the challenge speech string as a challenge speech, and performs the voice authentication process on the basis of determination on whether a response speech string that is recognized based on a response speech that is given from the user in response to the output challenge speech includes a hash value word, and

the hash value word has a predetermined relationship with the hash seed word, the predetermined relationship being defined by a word relation rule.

(2)

The information processing apparatus according to (1), wherein

the hash seed word has a hash seed attribute that is a predetermined attribute defined in advance, and

the hash value word has a hash value attribute that is a predetermined attribute defined in advance and for which a combination with the hash seed attribute is defined in advance.

(3)

The information processing apparatus according to (1) or (2), wherein the word relation rule is that one of a character and a syllable at a predetermined position in the hash value word is same as one of a character and a syllable at the predetermined position in the hash seed word.

(4)

The information processing apparatus according to any one of (1) to (3), wherein if presence of a different person is recognized, the authentication dialogue control unit generates the challenge speech string on the basis of the presence of the recognized different person, and outputs the challenge speech string as the challenge speech.

(5)

The information processing apparatus according to (4), wherein the authentication dialogue control unit determines a length of the challenge speech string on the basis of number of the recognized different persons, generates the determined challenge speech string, and outputs the challenge speech string as the challenge speech.

(6)

The information processing apparatus according to (5), wherein the authentication dialogue control unit generates the challenge speech string with a longer length with an increase in the number of the recognized different persons, and outputs the challenge speech string as the challenge speech.

(7)

The information processing apparatus according to any one of (4) to (6), wherein if the recognized different person was recognized in a past voice authentication process, the authentication dialogue control unit generates the challenge speech string that includes a hash seed word different from a hash seed word included in a challenge speech string that was generated in the past voice authentication process, and outputs the challenge speech string as the challenge speech.

(8)

The information processing apparatus according to any one of (4) to (6), wherein if the recognized different person was not recognized in a past voice authentication process, the authentication dialogue control unit generates the challenge speech string including a hash seed word included in a challenge speech string that was generated in the past voice authentication process, and outputs the challenge speech string as the challenge speech.

(9)

The information processing apparatus according to any one of (4) to (8), wherein the authentication dialogue control unit further generates a fake speech string that does not include the hash seed word, and outputs the fake speech string as a fake speech.

(10)

The information processing apparatus according to (9), wherein the authentication dialogue control unit determines number of fake speech strings on the basis of number of the recognized different persons, generates the determined number of fake speech strings, and outputs each of the fake speech strings as the fake speech.

(11)

The information processing apparatus according to (9) or (10), wherein the authentication dialogue control unit outputs the challenge speech and the fake speech in a random order.

(12)

The information processing apparatus according to any one of (1) to (11), wherein the authentication dialogue control unit determines a length of the challenge speech string on the basis of retry of the voice authentication process, generates the challenge speech string with the determined length, and outputs the challenge speech string as the challenge speech.

(13)

The information processing apparatus according to any one of (1) to (12), wherein the authentication dialogue control unit determines number of hash seed words included in the challenge speech string on the basis of retry of the voice authentication process, generates the challenge speech string including the determined number of hash seed words, and outputs the challenge speech string as the challenge speech.

(14)

The information processing apparatus according to any one of (1) to (13), wherein the authentication dialogue control unit determines the hash seed word and the word relation rule on the basis of user information on the user, generates the challenge speech string including the determined hash seed word, and outputs the challenge speech string as the challenge speech.

(15)

The information processing apparatus according to any one of (9) to (11), wherein

the authentication dialogue control unit performs one of positive determination and negative determination on a fake response speech string with respect to the fake speech, the fake response speech string being recognized based on a fake response speech that is given from the user in response to the output fake speech, and

one of the positive determination and the negative determination is used to generate the challenge speech string and the fake speech string.

(16)

An information processing apparatus comprising:

an authentication dialogue control unit that controls a dialogue with a user and performs a voice authentication process on the basis of a speech that is made by the user in the dialogue, wherein

the authentication dialogue control unit determines security strength of the voice authentication process to be performed, on the basis of a surrounding situation of the recognized user.

(17)

The information processing apparatus according to (16), wherein

the surrounding situation of the user includes number of recognized different persons, and

the authentication dialogue control unit determines the security strength of the voice authentication process to be performed, on the basis of the number of recognized different persons.

(18)

The information processing apparatus according to (17), wherein

the surrounding situation of the user includes whether a different person who was recognized in a past authentication process on the user is present, and

the authentication dialogue control unit determines the security strength of the voice authentication process to be performed, on the basis of whether the different person who was recognized in the past authentication process on the user is present.

(19)

An information processing method comprising:

controlling a dialogue with a user;

performing a voice authentication process on the basis of a speech that is made by the user in the dialogue;

generating a challenge speech string including a hash seed word;

outputting the challenge speech string as a challenge speech; and

performing the voice authentication process on the basis of determination on whether a response speech string that is recognized based on a response speech that is given from the user in response to the output challenge speech includes a hash value word, wherein

the hash value word has a predetermined relationship with the hash seed word, the predetermined relationship being defined by a word relation rule.

(20)

An information processing method comprising:

controlling a dialogue with a user;

performing a voice authentication process on the basis of a speech that is made by the user in the dialogue; and

determining security strength of the voice authentication process to be performed, on the basis of a surrounding situation of the recognized user.

### REFERENCE SIGNS LIST

10 information processing terminal
101 voice input unit
102 voice recognition unit
103 natural language processing unit
104 image input unit
105 image recognition unit
106 authentication dialogue control unit
107 voice synthesis unit
108 voice output unit
109 storage unit
110 communication unit
20 information processing server
30 network

1. An information processing apparatus comprising:
an authentication dialogue control unit that controls a dialogue with a user and performs a voice authentication process based on a speech that is made by the user in the dialogue, wherein
the authentication dialogue control unit generates a challenge speech string including a hash seed word, outputs the challenge speech string as a challenge speech, and performs the voice authentication process on the basis of determination on whether a response speech string that is recognized based on a response speech that is given from the user in response to the output challenge speech includes a hash value word, and
the hash value word has a predetermined relationship with the hash seed word, the predetermined relationship being defined by a word relation rule.

2. The information processing apparatus according to claim 1, wherein
the hash seed word has a hash seed attribute that is a predetermined attribute defined in advance, and
the hash value word has a hash value attribute that is a predetermined attribute defined in advance and for which a combination with the hash seed attribute is defined in advance.

3. The information processing apparatus according to claim 1, wherein the word relation rule is that one of a character and a syllable at a predetermined position in the hash value word is same as one of a character and a syllable at the predetermined position in the hash seed word.

4. The information processing apparatus according to claim 1, wherein if presence of a different person is recognized, the authentication dialogue control unit generates the challenge speech string on the basis of the presence of the recognized different person, and outputs the challenge speech string as the challenge speech.

5. The information processing apparatus according to claim 4, wherein the authentication dialogue control unit determines a length of the challenge speech string on the basis of number of the recognized different persons, generates the determined challenge speech string, and outputs the challenge speech string as the challenge speech.

6. The information processing apparatus according to claim 5, wherein the authentication dialogue control unit generates the challenge speech string with a longer length with an increase in the number of the recognized different persons, and outputs the challenge speech string as the challenge speech.

7. The information processing apparatus according to claim 4, wherein if the recognized different person was recognized in a past voice authentication process, the authentication dialogue control unit generates the challenge speech string that includes a hash seed word different from a hash seed word included in a challenge speech string that was generated in the past voice authentication process, and outputs the challenge speech string as the challenge speech.

8. The information processing apparatus according to claim 4, wherein if the recognized different person was not recognized in a past voice authentication process, the authentication dialogue control unit generates the challenge speech string including a hash seed word included in a challenge speech string that was generated in the past voice authentication process, and outputs the challenge speech string as the challenge speech.

9. The information processing apparatus according to claim 4, wherein the authentication dialogue control unit further generates a fake speech string that does not include the hash seed word, and outputs the fake speech string as a fake speech.

10. The information processing apparatus according to claim 9, wherein the authentication dialogue control unit determines number of fake speech strings on the basis of number of the recognized different persons, generates the determined number of fake speech strings, and outputs each of the fake speech strings as the fake speech.

11. The information processing apparatus according to claim 9, wherein the authentication dialogue control unit outputs the challenge speech and the fake speech in a random order.

12. The information processing apparatus according to claim 1, wherein the authentication dialogue control unit determines a length of the challenge speech string on the basis of retry of the voice authentication process, generates the challenge speech string with the determined length, and outputs the challenge speech string as the challenge speech.

13. The information processing apparatus according to claim 1, wherein the authentication dialogue control unit determines number of hash seed words included in the challenge speech string on the basis of retry of the voice authentication process, generates the challenge speech string including the determined number of hash seed words, and outputs the challenge speech string as the challenge speech.

14. The information processing apparatus according to claim 1, wherein the authentication dialogue control unit determines the hash seed word and the word relation rule on the basis of user information on the user, generates the challenge speech string including the determined hash seed word, and outputs the challenge speech string as the challenge speech.

15. The information processing apparatus according to claim 9, wherein
the authentication dialogue control unit performs one of positive determination and negative determination on a fake response speech string with respect to the fake speech, the fake response speech string being recognized based on a fake response speech that is given from the user in response to the output fake speech, and
one of the positive determination and the negative determination is used to generate the challenge speech string and the fake speech string.

16. An information processing apparatus comprising:
an authentication dialogue control unit that controls a dialogue with a user and performs a voice authentication process on the basis of a speech that is made by the user in the dialogue, wherein
the authentication dialogue control unit determines security strength of the voice authentication process to be performed, on the basis of a surrounding situation of the recognized user.

17. The information processing apparatus according to claim 16, wherein
the surrounding situation of the user includes number of recognized different persons, and
the authentication dialogue control unit determines the security strength of the voice authentication process to be performed, on the basis of the number of recognized different persons.

18. The information processing apparatus according to claim 17, wherein
the surrounding situation of the user includes whether a different person who was recognized in a past authentication process on the user is present, and
the authentication dialogue control unit determines the security strength of the voice authentication process to be performed, on the basis of whether the different person who was recognized in the past authentication process on the user is present.

19. An information processing method comprising:
controlling a dialogue with a user;
performing a voice authentication process on the basis of a speech that is made by the user in the dialogue;
generating a challenge speech string including a hash seed word;
outputting the challenge speech string as a challenge speech; and
performing the voice authentication process on the basis of determination on whether a response speech string that is recognized based on a response speech that is given from the user in response to the output challenge speech includes a hash value word, wherein
the hash value word has a predetermined relationship with the hash seed word, the predetermined relationship being defined by a word relation rule.

20. An information processing method comprising:
controlling a dialogue with a user;
performing a voice authentication process on the basis of a speech that is made by the user in the dialogue; and
determining security strength of the voice authentication process to be performed, on the basis of a surrounding situation of the recognized user.
